(19) United States
(12) Patent Application Publication
(10) Pub. No.: US 2012/0308808 A1
(43) Pub. Date: Dec. 6, 2012

(54) GAS BARRIER FILM AND METHOD FOR MANUFACTURING THE SAME

(75) Inventors: Ta-Jo LIU, Hsinchu (TW); Chin-Ghia LIU, Hsinchu (TW); Po-Hao TSAO, Hsinchu (TW); Hung-Chih CHEN, Hsinchu (TW)

(73) Assignee: NATIONAL TSING HUA UNIVERSITY, Hsinchu (TW)

(21) Appl. No.: 13/240,330

(22) Filed: Sep. 22, 2011

(30) Foreign Application Priority Data
May 31, 2011 (TW) 100119077

(51) Int. Cl. B32B 5/16; B32B 5/00; B32B 27/36; B32B 27/06; B32B 27/30; B32B 27/32; B32B 15/04; B32B 17/06; B32B 27/38; B32B 27/40; B05D 1/36; B32B 37/00; B32B 37/12; B32B 9/04; B82Y 30/00

(52) U.S. Cl. 428/323; 428/411.1; 428/446; 428/497; 428/334; 428/480; 428/419; 428/473.5; 428/412; 428/522; 428/523; 428/457; 428/426; 428/413; 428/423.1; 428/447; 427/402; 156/308.2; 156/60; 977/773; 977/810; 977/811; 977/742; 977/962

(57) ABSTRACT

A gas barrier film and method for manufacturing the abovementioned gas barrier film are disclosed in the present invention. The gas barrier film is applied in electronic product, food, medicine and other fields for protecting them from gas and water. The gas barrier film comprises a gas barrier layer and pluralities of cladding layers. The gas barrier layer is a liquid layer, and the cladding layers are disposed on the opposite surface of the gas barrier layer.

### CROSS-REFERENCE TO RELATED APPLICATIONS

This Non-provisional application claims priority under 35 U.S.C. §119(a) on Patent Application No(s). 100119077 filed in Taiwan, Republic of China, May, 31, 2011, the entire contents of which are hereby incorporated by reference.

### FIELD OF THE INVENTION

This invention relates to a gas barrier film, especially relates to a gas barrier film comprising liquid and a method for manufacturing the same.

### BACKGROUND OF THE INVENTION

The global market for consumer optical-electronic products is not only huge but also grows rapidly. The competition for innovative ideas and new designs is extremely stiff among all the manufacturers. Recently, organic light emitting diodes, organic solar cells, thin-film solar cells, flexible liquid crystal display panels and electronic papers have become new and potential market attractions. In addition to the general demands such as the products have to be light, thin, easy to carry, other requirements such as durability, flexibility are also highly desirable. Conventionally glass has been applied to cover and protect various optical-electronic products, however, owing to the lack of flexibility and high cost, plastic materials have been considered to replace glass to serve as protecting materials of the optical-electronic products.

The plastic covers are thin, light and flexible, which can avoid the disadvantages of the traditional glass covers. However, the main disadvantages of the plastic cover is that it can not effectively protect the optical-electronic products from the penetration of water and gas. The quality and functions of the optical-electronic devices deteriorate rapidly once the key components and chemicals inside the devices contact water and gas.

Recently, the gas barrier film has served as a powerful means to protect the optical-electronic products and avoid the aforesaid disadvantages. The gas barrier film can protect the components in the electronics from gas and water and further maintain the functions of them. Because several materials and methods can be used for manufacturing the gas barrier film, there are many defects produced during the manufacturing process. For example, if the stress balance cannot be achieved between the two different phases, the surface of the substrate is always not uniform. Furthermore, those defects will result in non-uniform sizes or rough surface of the gas barrier film. In addition, some materials used for manufacturing are not flexible such as an inorganic material, therefore, the gas barrier film will be cracked easily during a bending process. According to the abovementioned, those defects will deteriorate the quality of the gas barrier film; and further, water and gas will penetrate into the electronics through those defects. That is, the prior disadvantages cannot be solved.

### SUMMARY OF THE INVENTION

The present invention discloses a gas barrier film which comprises a liquid layer for protecting a product from gas and water by taking advantage of its continuity. Furthermore, the present invention can avoid the defects of the solid material which occur easily during the drying process.

The first purpose of the present invention is to provide a gas barrier film, which comprises a gas barrier layer and pluralities of cladding layers, for protecting a product from gas and water. The gas barrier layer is a liquid layer, and the cladding layers are disposed separately on the opposite surfaces of the gas barrier layer.

Preferably, the gas barrier layer is a non-volatile liquid or a liquid which comprises nanoparticles; the former can be selected from a group consisting of lubricant, silicon oil, glycerol, ionic liquid, inedible soybean oil and non-volatile organic alcohol, the latter can be selected from a group consisting of silicon oxide nanoparticles, titanium oxide nanoparticles, nickel nanoparticles, silver nanoparticles, carbon nanotubes and clay nanoparticles.

Preferably, the gas barrier layer is a liquid colloid.

Preferably, the viscosity of the gas barrier layer has a value between 1 mPa·s and 1000 mPa·s.

Preferably, the thickness of the gas barrier layer has a value between 20 μm and 100 μm.

Preferably, the gas barrier layer is a non-volatile liquid.

Preferably, at least one of the cladding layers is a substrate which can be selected from a group consisting of polyethylene terephthalate, polyethylene napathalate, polyether sulfone, polyimide, polycarbonate, acrylite, cyclic olefin copolymer, metal foil and flexible glass.

Preferably, at least one of the cladding layers comprises an adhesive which is a thermosetting resin or a UV curable resin.

Preferably, the adhesive can be a UV curable resin and selected from a group consisting of acrylic, epoxy, polyimide, polyester, polyurethane and silicone.

Preferably, the gas barrier film further comprises a dispersion layer. The dispersion layer covers the cladding layers which are disposed on one of the opposite surfaces of the gas barrier layer and is a nanomaterial which can be selected from a group consisting of silicon oxide nanoparticle dispersions, titanium oxide nanoparticle dispersions, nickel nanoparticle dispersions, siliver nanoparticle dispersions, carbon nanotube dispersions and clay nanoparticle dispersions.

Preferably, the transparency of the gas barrier film has a value larger than 85%.

The second purpose of the present invention is to provide a method for manufacturing the gas barrier film, and the method comprises the following steps. The first step is to be executed by coating the gas barrier layer on one of the cladding layers through a wet coating process. The second step is to be executed by covering the other one of the cladding layers on the gas barrier layer.

Preferably, the aforesaid second step is executed by adhesion.

Preferably, the wet coating process can be a bar coating process, a blade coating process, a roller coating process, a dip coating process, a spin coating process, a slot die coating process, a curtain coating process and a slide coating process.

Preferably, the manufacturing method of the gas barrier film further comprises a third step which is to be executed by sealing spaces between one and the other one of the cladding layers.

Preferably, the third step is executed with a UV curable resin or a solid material which can be a metal material, an organic material or an inorganic material.

The features and advantages of the present invention will be understood and illustrated in the following specifications and FIGS. 1˜3B.

### BRIEF DESCRIPTION OF THE DRAWINGS

FIG. 1 shows the cross section of the gas barrier film according to the first embodiment in the present invention;

FIG. 2 shows the cross section of the gas barrier film according to the second embodiment in the present invention;

FIG. 3A shows the cross section of the gas barrier film according to the third embodiment in the present invention; and

FIG. 3B shows the cross section of the gas barrier film according to the fourth embodiment in the present invention.

### DETAILED DESCRIPTION OF THE INVENTION

According to the abovementioned disclosure, the present invention provides a gas barrier film applied in a product such as an electronic product, food and medicine for protecting the product from gas and water. Preferably, the electronic product can be an organic light emitting diode, an organic solar cell, a thin-film solar cell, a flexible liquid crystal display panel and an electronic paper. Preferred embodiments will be illustrated with the figures as below.

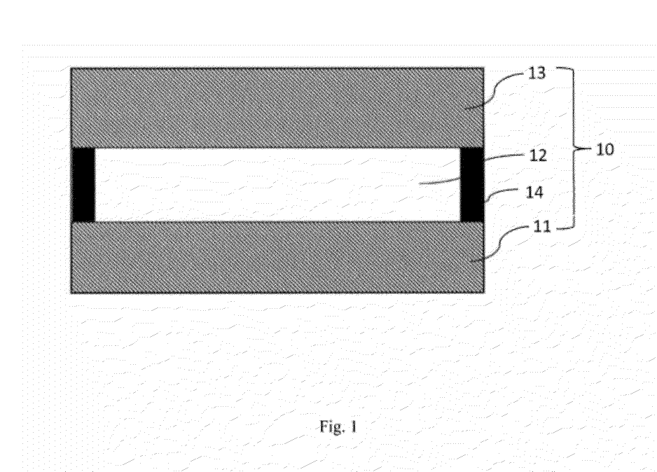

FIG. 1 shows the cross section of the gas barrier film 10 according to the first embodiment in the present invention. The gas barrier film 10 comprises a gas barrier layer 12 and pluralities of cladding layers 11, 13 as shown in FIG. 1. The gas barrier layer 12 is a liquid layer. The cladding layers 11, 13 are disposed on the opposite surface of the gas barrier layer 12 and are both substrates, that is to say, the gas barrier layer 12 is disposed between the two substrates in the first embodiment. As to the method for disposing the gas barrier layer 12 will be illustrated later.

Preferably, the cladding layers 11, 13 can use same materials or not, and the materials are selected from a group consisting of polyethylene terephthalate, polyethylene napathalate, polyether sulfone, polyimide, polycarbonate, acrylite, cyclic olefin copolymer, metal foil and flexible glass. Polyethylene terephthalate and polyethylene napathalate are often used, particularly polyethylene terephthalate which is applied in flexible electronics due to its competitive price and superior optical and mechanical properties. Furthermore, the transparency of the substrates must have a value larger than 85% if the gas barrier film is applied in optical electronics.

The spaces, which exist between the cladding layers 11, 13, can be sealed with a UV curable resin or a solid material 14 so as to seal the gas barrier layer 12 between them. Preferably, the solid material 14 can be a metal material, an organic material or an inorganic material.

The gas barrier layer 12 is a liquid layer so that the gas barrier film of the present invention can protect a product from gas and water well due to the continuity of the liquid; and further, it can be a volatile liquid, a non-volatile liquid or a liquid colloid. Preferably, the viscosity of the gas barrier layer 12 has a value between 1 mPa·s and 1000 mPa·s, and the thickness of the gas barrier layer 12 is between 20 μm and 100 μm. Preferably, the gas barrier layer 12 is the non-volatile liquid which can be selected from a group consisting of lubricant, silicon oil, glycerol, ionic liquid, inedible soybean oil and volatile organic alcohol. However, the compatibility between the gas barrier layer 12 and the cladding layers 11, 13 is more important. Thus the volatile liquid or the liquid colloid can be selected as the gas barrier layer 12, too. The present invention is not limited thereto.

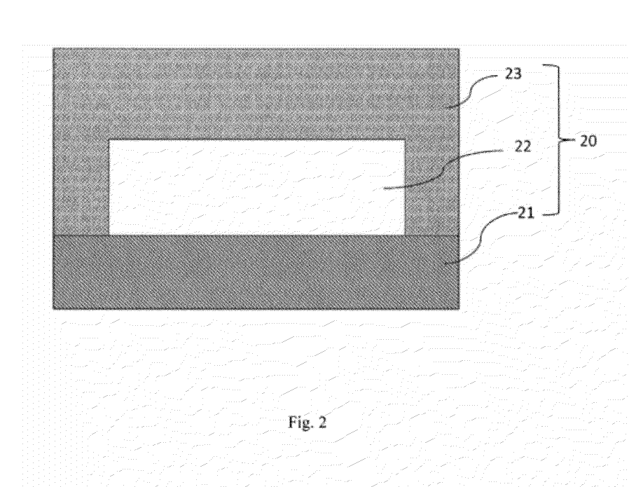

FIG. 2 shows the cross section of the gas barrier film 20 according to the second embodiment in the present invention. The structure of the gas barrier film 20 is similar with the gas barrier film 10 except that the cladding layer 23 of the second embodiment is not a substrate but an adhesive.

The cladding layer 23 of the second embodiment is a thermosetting resin or a UV curable resin. Preferably, the UV curable resin has a better cross-link structure than the thermosetting resin so that it can avoid defects which appear in the drying process to result in leakage of the sealing process. However, the present invention is not limited thereto. Please refer to FIG. 2. a liquid layer (hereafter, referred to as “the gas barrier layer 22”) will be coated on a substrate (hereafter, referred to as “the cladding layer 21”). The UV curable resin (hereafter, referred to as “the cladding layer 23”) is then coated on the gas barrier layer 22, and the gas barrier layer 22 is sealed therein after curing. In other words, the gas barrier layer 22 can be adhered inside the cladding layer 23 which is selected as the adhesive and from a group consisting of acrylic, epoxy, polyimide, polyester, polyurethane and silicone.

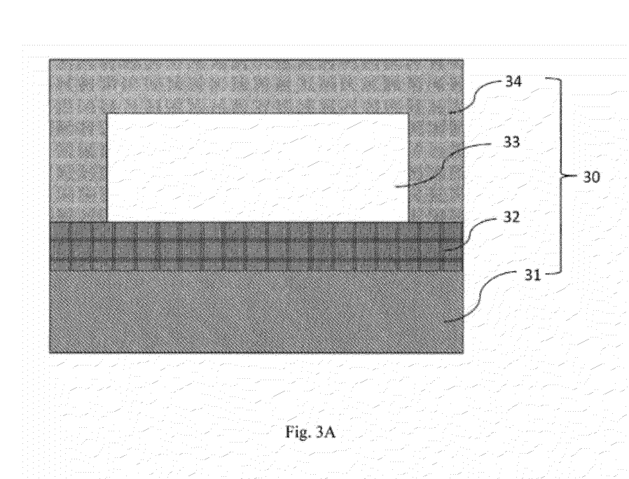

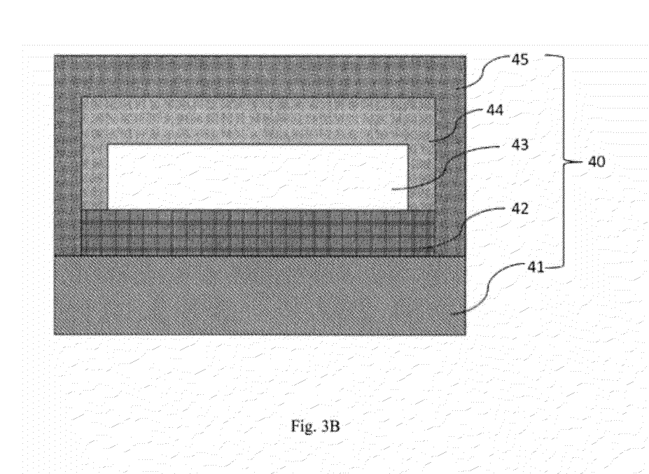

Please refer to FIGS. 3A and 3B. The former shows the cross section of the gas barrier film 30 according to the third embodiment in the present invention, the latter shows the cross section of the gas barrier film 40 according to the fourth embodiment in the present invention. The difference between the gas barrier film 30, the gas barrier film 40 and the gas barrier film 20 is that another adhesive (hereafter, referred to as “the cladding layers 32, 42”) will be coated on the substrates (hereafter, referred to as “the cladding layers 31, 41”) first. In other words, the cladding layers 32, 42 are disposed between the gas barrier layers 33, 43 and the cladding layers 31, 41. Preferably, the cladding layers 32, 42 are also adhesive such as the UV curable resin.

As to the difference between the gas barrier film 30 and the gas barrier film 40, there is a dispersion layer 45 coated on the cladding layer 44. Please refer to FIG. 3B, the cladding layer 42 is coated on the cladding layer 41 and the gas barrier layer 43 is coated thereon. The cladding layer 44 is then coated to cover the gas barrier layer 43, and the dispersion layer 45 will be coated thereon. The most important is that the gas barrier layer 43 and the cladding layers 42, 44 will be totally covered inside the dispersion layer 45 to increase the leakproofness of the gas barrier layer 43 for preventing leakage.

Preferably, the dispersion layer 45 is a dispersion and can be silicon oxide nanoparticle dispersions, titanium oxide nanoparticle dispersions, nickel nanoparticle dispersions, siliver nanoparticle dispersions, carbon nanotube dispersions and clay nanoparticle dispersions. Furthermore, the silicon oxide nanoparticle dispersions will be preferred due to its good thermal properties and gas barrier properties. For example, the coefficient of thermal expansion of the silicon oxide nanoparticle dispersions has a value about 3×10⁻⁸ m/° C. However, the present invention is not limited thereto.

The second purpose of the present invention is to manufacture the gas barrier film by using a wet coating process. However, the main purpose of the present invention is to use a liquid layer for protecting the product from gas and water so that the manufacturing method is not limited to the wet coating process or a combination of a wet coating process and a lamination process. In other words, the main step herein is to coat a thin-film liquid layer in the gas barrier film by using the wet coating process. Thus the first step of the method is to be executed by coating a liquid layer (hereafter, referred to as “the gas barrier layer”) on one of the cladding layers, that is the substrate. The second step is to be executed by coating and covering the other one of the cladding layers on the gas barrier layer. Preferably, the second step is executed by adhesion.

The method further comprises a third step which is to be executed by sealing the spaces of the cladding layers while the two cladding layers are both substrates. Besides, the gas barrier layer can be sealed inside the adhesives when one of the cladding layers is the substrate and the other one of them is the adhesive.

Preferably, the wet coating process can be a bar coating process, a blade coating process, a roller coating process, a dip coating process, a spin coating process, a slot die coating process, a curtain coating process and a slide coating process. Furthermore, the gas barrier film with high quality can be manufactured via patch-by-patch process or roll-to-roll process after ripening of the technique.

In the meanwhile, coating layers with different functions can be added on the gas barrier film such as an anti-scratch layer, a thermal barrier layer, an anti-glare layer, an anti-reflection layer, a polarizing layer and a conducting layer.

To summarize, a liquid layer of the present invention is coated on a substrate by using a wet coating process. A prototype of manufacturing a gas barrier film by using the wet coating process is developed due to its low cost. In the meantime, the liquid layer is sealed by using an adhesive to omit a drying process for further preventing the prior defects which appear in the drying process. Furthermore, the gas barrier film of the present invention can further take advantage of the continuity of the liquid layer to protect the product from gas and water well. Preferably, only one gas barrier film is needed to achieve the abovementioned purpose for remarkably decreasing the cost of manufacturing the gas barrier film. That is, the present invention can provide the gas barrier film with high quality and low price in the future.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A gas barrier film applied in a product for protecting the product from gas and water, comprising:
a gas barrier layer containing a liquid layer, and
pluralities of cladding layers disposed on a surface opposite the gas barrier layer.

2. The gas barrier film according to claim 1, wherein the gas barrier layer is a non-volatile liquid which can be selected from a group consisting of lubricant, silicon oil, glycerol, ionic liquid, inedible soybean oil and volatile organic alcohol.

3. The gas barrier film according to claim 2, wherein the non-volatile liquid further comprises nanoparticles.

4. The gas barrier film according to claim 3, wherein the nanoparticles is selected from a group consisting of silicon oxide nanoparticles, titanium oxide nanoparticles, nickel nanoparticles, silver nanoparticles, carbon nanotubes, and clay nanoparticles.

5. The gas barrier film according to claim 1, wherein the liquid layer is a liquid colloid.

6. The gas barrier film according to claim 1, wherein the viscosity of the gas barrier layer has a value between 1 mPa·s and 1000 mPa·s.

7. The gas barrier film according to claim 1, wherein the thickness of the gas barrier layer has a value between 20 μm and 100 μm.

8. The gas barrier film according to claim 1, wherein the liquid layer is a non-volatile liquid.

9. The gas barrier film according to claim 1, wherein at least one of the cladding layers is a substrate selected from a group consisting of polyethylene terephthalate, polyethylene napathalate, polyether sulfone, polyimide, polycarbonate, acrylite, cyclic olefin copolymer, metal foil, and flexible glass.

10. The gas barrier film according to claim 1, wherein at least one of the cladding layers comprises an adhesive containing a thermosetting or UV curable resin.

11. The gas barrier film according to claim 1, wherein the adhesive is UV curable resin and selected from a group consisting of acrylic, epoxy, polyimide, polyester, polyurethane and silicone.

12. The gas barrier film according to claim 1, further comprising:
a dispersion layer covering the cladding layers which are disposed on a surface opposite that of the gas barrier layer; the dispersion layer is a nanomaterial selected from the group consisting of: silicon oxide nanoparticle dispersions, titanium oxide nanoparticle dispersions, nickel nanoparticle dispersions, silver nanoparticle dispersions, carbon nanotube dispersions, and clay nanoparticle dispersions.

13. The gas barrier film according to claim 1, wherein the transparency of the gas barrier film has a value larger than 85%.

14. A method for manufacturing the gas barrier film according to claim 1, comprising the following steps:
coating the gas barrier layer through a wet coating process; and
covering the cladding layers on the gas barrier layer with a dispersion layer.

15. The method for manufacturing the gas barrier film according to claim 14, wherein the step of covering the other one of the cladding layers on the gas barrier layer is performed by adhesion.

16. The method for manufacturing the gas barrier film according to claim 14, wherein the wet coating process is selected from the group consisting of a bar coating process, a blade coating process, a roller coating process, a dip coating process, a spin coating process, a slot die coating process, a curtain coating process and a slide coating process.

17. The method for manufacturing the gas barrier film according to claim 14, further comprising sealing spaces between layers of the cladding layers.

18. The method for manufacturing the gas barrier film according to claim 17, wherein the step of sealing the spaces between layers of the cladding layers is performed with a UV curable resin or a solid material which can be a metal material, a organic material or an inorganic material.

19. The method for manufacturing the gas barrier film according to claim 17, wherein the step of sealing the spaces between the cladding layers includes selecting a solid material selected from the group consisting of: metal material, organic material, and inorganic material.
